(19) United States
(12) Patent Application Publication
(10) Pub. No.: US 2026/0273935 A1
(43) Pub. Date: Sep. 17, 2026

(54) Liquid Ejecting Head

(71) Applicant: SEIKO EPSON CORPORATION, Tokyo (JP)

(72) Inventors: Takanori AIMONO, Shiojiri (JP); Takahiro KATAKURA, Okaya (JP); Mitsuki EBISAWA, Shiojiri (JP); Toshihiro SHIMIZU, Fujimi (JP); Yuma FUKUZAWA, Matsumoto (JP)

(21) Appl. No.: 19/563,330

(22) Filed: Mar. 11, 2026

(30) Foreign Application Priority Data
Mar. 12, 2025 (JP) 2025-039498

(51) Int. Cl. B41J 2/14; B41J 2/045

(52) U.S. Cl. CPC B41J 2/1433; B41J 2/04581; B41J 2/14233; B41J 2002/14475; B41J 2202/03; B41J 2202/07

(57) ABSTRACT

A liquid ejecting head includes a nozzle that ejects liquid, in which the nozzle includes a first nozzle portion that ejects the liquid, the first nozzle portion includes a scalloped structure having a plurality of convex portions and a plurality of concave portions on a side surface along an ejection direction in which the liquid is ejected from the first nozzle portion, a wettable film having wettability is provided on at least one of the plurality of convex portions in the scalloped structure of the first nozzle portion, and wettability of the at least one convex portion is higher than wettability of a concave portion adjacent to the at least one convex portion in the ejection direction.

The present application is based on, and claims priority from JP Application Serial Number 2025-039498, filed Mar. 12, 2025, the disclosure of which is hereby incorporated by reference herein in its entirety.

### BACKGROUND

### 1. Technical Field

The present disclosure relates to a liquid ejecting head.

### 2. Related Art

JP-A-2009-119724 describes that an inner wall of a nozzle hole is hydrophilized. JP-A-2018-2778 describes that a lower stage of a two-stage nozzle has a scalloped shape.

A position of a meniscus that is formed in a nozzle relates to straightness of liquid ejected from the nozzle. That is, when a meniscus is formed in the nozzle in a posture that is inclined with respect to a plate surface of a nozzle plate, liquid droplets are ejected in a direction deflected from the nozzle. Therefore, it is preferable to form a meniscus in a posture parallel to the plate surface of the nozzle plate.

In the technique described in JP-A-2009-119724, the inner wall of the nozzle hole is hydrophilized over the entire area. Therefore, there is a problem in that the position of the meniscus to be formed in the nozzle is not stable.

In the technique described in JP-A-2018-2778, although a decrease in the degree of freedom for the position of the meniscus to be formed in the nozzle is expected due to the scalloped shape, there is room for improvement in stabilizing the position of the meniscus to be formed in the nozzle.

### SUMMARY

According to an aspect of the present disclosure, a liquid ejecting head includes a nozzle that ejects liquid, in which the nozzle includes a first nozzle portion that ejects the liquid, the first nozzle portion includes a scalloped structure having a plurality of convex portions and a plurality of concave portions on a side surface along an ejection direction in which the liquid is ejected from the first nozzle portion, a wettable film having wettability is provided on at least one of the plurality of convex portions in the scalloped structure of the first nozzle portion, and wettability of the at least one convex portion is higher than wettability of a concave portion adjacent to the at least one convex portion in the ejection direction.

### BRIEF DESCRIPTION OF THE DRAWINGS

FIG. 1 is a schematic view illustrating a configuration example of a liquid ejecting apparatus according to a first embodiment.

FIG. 2 is an exploded perspective view illustrating a liquid ejecting head according to the first embodiment.

FIG. 3 is a cross-sectional view taken along the line III-III in FIG. 2.

FIG. 4 is a cross-sectional view illustrating a nozzle according to the first embodiment.

FIG. 5 is a schematic view illustrating a first nozzle portion according to the first embodiment.

FIG. 6 is a diagram illustrating a nozzle not having a scalloped structure and having uniform wettability on a wall surface.

FIG. 7 is a diagram illustrating a nozzle having a scalloped structure and having uniform wettability on a wall surface.

FIG. 8 is a diagram illustrating an example of a drive signal.

FIG. 9 is a cross-sectional view illustrating a nozzle according to a second embodiment.

FIG. 10 is a cross-sectional view illustrating a nozzle according to a third embodiment.

### DESCRIPTION OF EMBODIMENTS

Hereinafter, preferred embodiments according to the present disclosure will be described with reference to the accompanying drawings. In the drawings, dimensions and scales of each section are different from the actual dimensions or scales as appropriate, and some sections are schematically illustrated for easy understanding. Further, the scope of the present disclosure is not limited to these embodiments unless it is noted in the following description that the present disclosure is particularly limited.

For the sake of convenience, the following description will be made by using an X-axis, a Y-axis, and a Z-axis that intersect with each other, as appropriate. In the following, one direction along the X-axis is an X1 direction, and a direction opposite to the X1 direction is an X2 direction. Similarly, directions opposite to each other along the Y-axis are a Y1 direction and a Y2 direction. The Y1 direction or the Y2 direction is an example of “first direction”. In addition, directions opposite to each other along the Z-axis are a Z1 direction and a Z2 direction. The Z1 direction is an example of “second direction”. Hereinafter, viewing in the Z1 direction or the Z2 direction will also be referred to as “plan view”.

Here, typically, the Z-axis is a vertical axis, and the Z2 direction corresponds to a downward direction in the vertical direction. However, the Z-axis does not need to be the vertical axis. The X-axis, the Y-axis, and the Z-axis are typically orthogonal to each other, but are not limited thereto, and may intersect each other at an angle within a range of, for example, 80° or more and 100° or less.

### 1. First Embodiment

### 1-1: Overall Configuration of Liquid Ejecting Apparatus

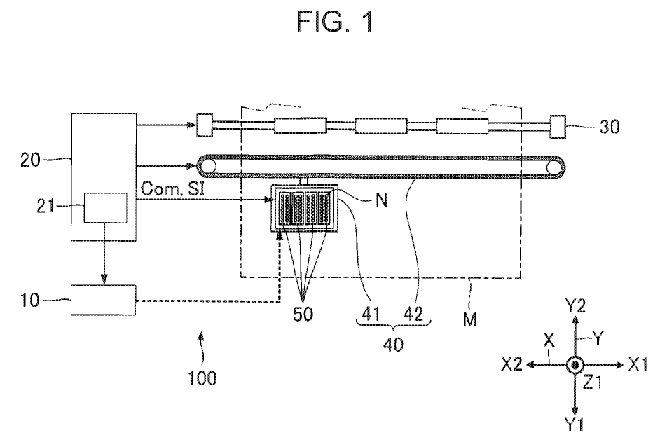

FIG. 1 is a schematic view illustrating a configuration example of a liquid ejecting apparatus 100 according to a first embodiment. The liquid ejecting apparatus 100 is an ink jet printing apparatus that ejects ink, which is an example of a “liquid”, onto a recording medium M as liquid droplets. For example, the recording medium M is printing paper. The recording medium M is not limited to the printing paper, and may be, for example, a printing target of any material such as a resin film or a cloth.

As illustrated in FIG. 1, the liquid ejecting apparatus 100 includes a liquid container 10, a control module 20, a transport mechanism 30, a movement mechanism 40, and a plurality of liquid ejecting heads 50. The control module 20 is an example of a “control portion”.

The liquid container 10 stores ink. Examples of specific aspects of the liquid container 10 include a cartridge that can be attached to and detached from the liquid ejecting apparatus 100, a bag-shaped ink pack formed of a flexible film, and an ink tank that can be refilled with the ink. A type of the ink stored in the liquid container 10 is optional.

The control module 20 controls an operation of each element of the liquid ejecting apparatus 100. For example, the control module 20 includes a processing circuit such as a central processing unit (CPU) or a field programmable gate array (FPGA) and a memory circuit such as a semiconductor memory. Here, the control module 20 outputs a drive signal Com for driving the liquid ejecting head 50 and a control signal SI for controlling the drive of the liquid ejecting head 50. The control module 20 controls an ejection operation from the liquid ejecting head 50 using the drive signal Com and the control signal SI.

In the present embodiment, the control module 20 functions as a control portion 21. The control portion 21 controls a position of a meniscus ME that is formed in a first nozzle portion N1 of a nozzle N described below. The control portion 21 controls, for example, an operation of a mechanism for adjusting a pressure (back pressure) of the ink to be supplied from the liquid container 10 to the liquid ejecting head 50. As a result, the position of the meniscus ME is controlled by the control portion 21.

The transport mechanism 30 transports the recording medium M along the Y-axis under the control of the control module 20.

The movement mechanism 40 reciprocates the liquid ejecting head 50 along the X-axis under the control of the control module 20. The movement mechanism 40 includes a carriage 41 that houses the liquid ejecting head 50, and an endless transport belt 42 to which the carriage 41 is fixed. The liquid container 10 may be mounted on the carriage 41, in addition to the liquid ejecting head 50.

Each of the plurality of liquid ejecting heads 50 ejects the ink supplied from the liquid container 10 from each of a plurality of nozzles N on the recording medium M under the control of the control module 20. By performing the ejection in parallel with the transport of the recording medium M via the transport mechanism 30 and the reciprocating movement of the liquid ejecting head 50 via the movement mechanism 40, an image is formed at a surface of the recording medium M using the ink.

In the example illustrated in FIG. 1, the number of the liquid ejecting heads 50 is four. The number of the liquid ejecting heads 50 is not limited to the example illustrated in FIG. 1, and may be any number, may be one, or may be a plural number of three or less or five or more. In addition, the arrangement of the plurality of liquid ejecting heads 50 is not limited to the example illustrated in FIG. 1, and can be freely determined.

### 1-2: Liquid Ejecting Head

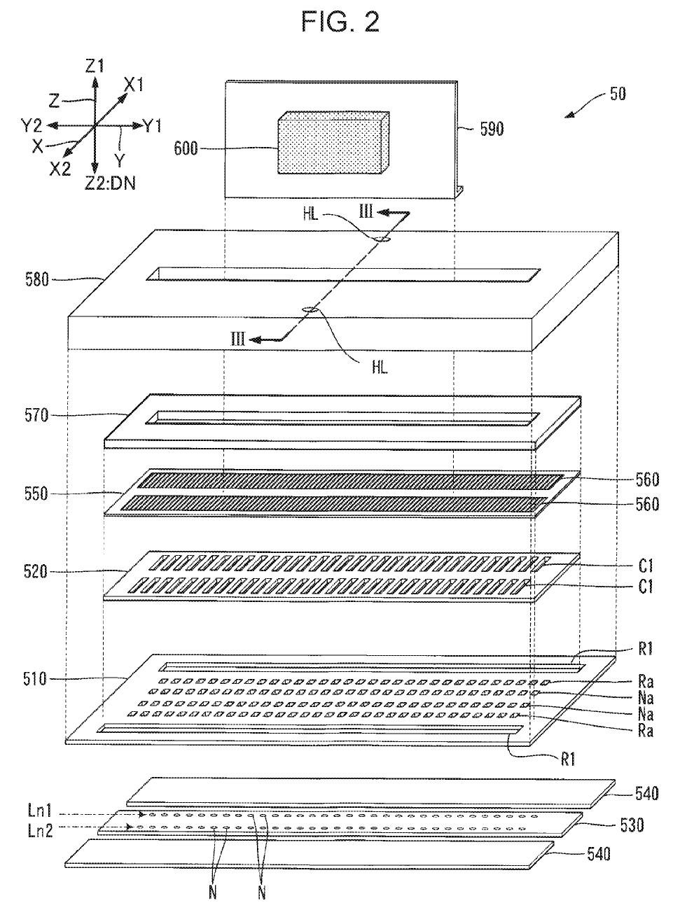

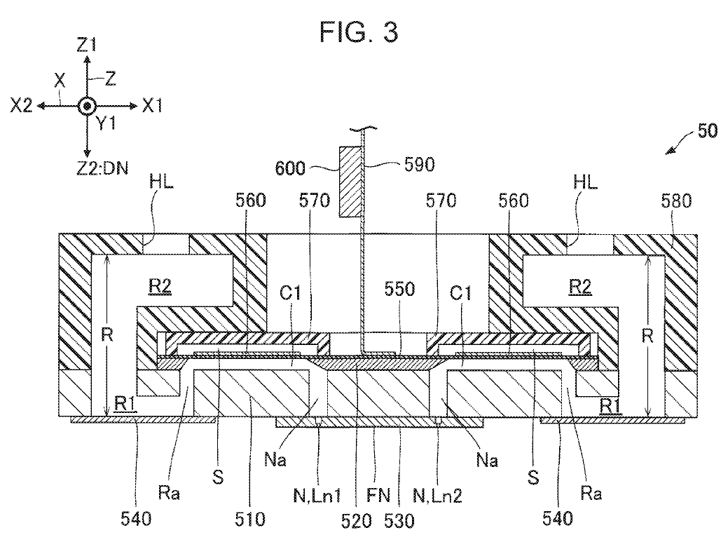

FIG. 2 is an exploded perspective view illustrating the liquid ejecting head 50 according to the first embodiment. FIG. 3 is a cross-sectional view taken along the line III-III in FIG. 2. Hereinafter, an example of the configuration of the liquid ejecting head 50 will be described.

As illustrated in FIGS. 2 and 3, the liquid ejecting head 50 includes a plurality of nozzles N that eject the ink in an ejection direction DN. In the present embodiment, the ejection direction DN is the Z2 direction.

The plurality of nozzles N in the liquid ejecting head 50 are divided into a first nozzle row Ln1 and a second nozzle row Ln2 arranged at intervals in the direction along the X-axis. Each of the first nozzle row Ln1 and the second nozzle row Ln2 is a set of the plurality of nozzles N linearly arranged in the direction along the Y-axis.

The liquid ejecting head 50 is configured to be substantially symmetrical about the X-axis. However, positions of the plurality of nozzles N of the first nozzle row Ln1 and the plurality of nozzles N of the second nozzle row Ln2 in the direction along the Y-axis may coincide with or may be different from each other. FIGS. 2 and 3 illustrate a configuration in which the positions of the plurality of nozzles N of the first nozzle row Ln1 and the plurality of nozzles N of the second nozzle row Ln2 coincide with each other in the direction along the Y-axis.

As illustrated in FIGS. 2 and 3, the liquid ejecting head 50 includes a communication substrate 510, a pressure chamber substrate 520, a nozzle plate 530, a vibration absorbing body 540, a vibration plate 550, a plurality of piezoelectric elements 560, a protective substrate 570, a case 580, and a wiring substrate 590.

The communication substrate 510 and the pressure chamber substrate 520 are laminated in this order in the Z1 direction, and form a flow path for supplying the ink to the plurality of nozzles N. The vibration plate 550, the plurality of piezoelectric elements 560, the protective substrate 570, the case 580, the wiring substrate 590, and a drive circuit 600 are provided in a region that is positioned in the Z1 direction further than a laminate including the communication substrate 510 and the pressure chamber substrate 520. On the other hand, the nozzle plate 530 and the vibration absorbing body 540 are provided in a region positioned in the Z2 direction further than the laminate. The elements of the liquid ejecting head 50 are approximately plate-shaped members elongated in the Y direction, and are bonded to each other by, for example, an adhesive. Hereinafter, each element of the liquid ejecting head 50 will be described in order.

The nozzle plate 530 is a plate-shaped member provided with the plurality of nozzles N of each of the first nozzle row Ln1 and the second nozzle row Ln2. Each of the plurality of nozzles N is a through-hole through which the ink passes. Here, a surface of the nozzle plate 530 facing the Z2 direction is a nozzle surface FN. The nozzle plate 530 is manufactured, for example, by processing a silicon single crystal substrate with a semiconductor manufacturing technique using a processing technique such as dry etching or wet etching. However, other known methods and materials may be appropriately used for manufacturing the nozzle plate 530. In addition, the cross-sectional shape of the nozzle N is typically a circular shape, but the shape is not limited thereto, and may be, for example, a non-circular shape such as a polygonal or elliptical shape.

The communication substrate 510 is provided with a flow path R1, a plurality of supply flow paths Ra, and a plurality of communication flow paths Na for each of the first nozzle row Ln1 and the second nozzle row Ln2. The flow path R1 is a flow path provided in common with the plurality of nozzles N, is a flow path communicating with the plurality of nozzles N and upstream of the nozzles N, and includes an elongated hole extending in the direction along the Y-axis in a plan view viewed in the direction along the Z-axis. Each of the supply flow paths Ra and the communication flow paths Na is a flow path including a through-hole formed for each nozzle N. Each of the supply flow paths Ra communicates with the flow path R1.

As in the nozzle plate 530 described above, the communication substrate 510 is manufactured, for example, by processing a silicon single crystal substrate with a semiconductor manufacturing technique using a processing technique such as dry etching or wet etching. However, other known methods and materials may be appropriately used for manufacturing the communication substrate 510.

The pressure chamber substrate 520 is a plate-shaped member in which a plurality of pressure chambers C1 called cavities are provided for each of the first nozzle row Ln1 and the second nozzle row Ln2. The plurality of pressure chambers C1 are arranged in the direction along the Y-axis. Each pressure chamber C1 is an elongated space formed for each nozzle N and extending in the direction along the X-axis in a plan view. The pressure chamber C1 is filled with liquid to be ejected from the nozzles N.

As in the nozzle plate 530 described above, the pressure chamber substrate 520 is manufactured, for example, by processing a silicon single crystal substrate with a semiconductor manufacturing technique using a processing technique such as dry etching or wet etching. However, other known methods and materials may be appropriately used for manufacturing the pressure chamber substrate 520.

The pressure chamber C1 is positioned between the communication substrate 510 and the vibration plate 550. The plurality of pressure chambers C1 are arranged in the direction along the Y-axis for each of the first nozzle row Ln1 and the second nozzle row Ln2. In addition, the pressure chamber C1 communicates with each of the communication flow path Na and the supply flow path Ra. Accordingly, the pressure chambers C1 communicate with the nozzles N through the communication flow path Na and communicate with the flow path R1 through the supply flow path Ra.

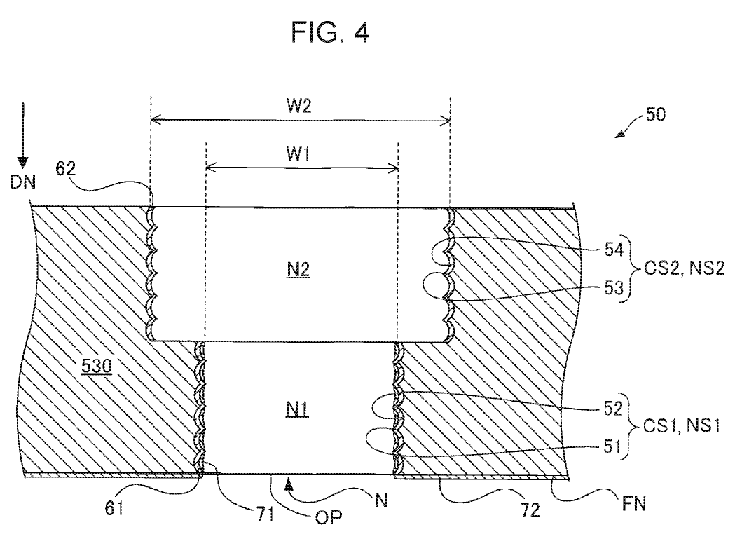

The vibration plate 550 is disposed on the pressure chamber substrate 520, more specifically, on a surface of the pressure chamber substrate 520 facing the Z1 direction. The vibration plate 550 is a plate-shaped member that can be elastically vibrated, and is vibrated by the piezoelectric element 560. Although not illustrated in the drawing, for example, as illustrated in FIG. 4, the vibration plate 550 includes an elastic film formed of silicon oxide (SiO₂) and an insulating film formed of zirconium oxide (ZrO₂), and these films are laminated in this order in the Z1 direction. The elastic film is formed, for example, by thermally oxidizing one surface of a silicon single crystal substrate. The insulating film is formed, for example, by forming a zirconium layer by a sputtering method and thermally oxidizing the layer. The vibration plate 550 is not limited to the above-described configuration in which the elastic film and the insulating film are laminated, and may be formed of, for example, a single layer or three or more layers.

The plurality of piezoelectric elements 560 corresponding to the nozzles N are arranged on a surface of the vibration plate 550 facing the Z1 direction for each of the first nozzle row Ln1 and the second nozzle row Ln2. Each piezoelectric element 560 is a passive element that is deformed by supplying a potential corresponding to the drive signal Com, and causes a pressure fluctuation in the ink in the pressure chamber C1. This way, the piezoelectric element 560 is driven by the drive signal Com, and the volume of the pressure chamber C1 changes depending on the drive of the piezoelectric element. Each of the piezoelectric elements 560 has an elongated shape extending in the direction along the X-axis in a plan view. The plurality of piezoelectric elements 560 are arranged in the direction along the Y-axis to correspond to the plurality of pressure chambers C1. The piezoelectric element 560 overlaps the pressure chamber C1 in a plan view. The above-described piezoelectric element 560 applies a pressure to the pressure chamber C1 communicating with the nozzle N that ejects the ink.

Although not shown, for example, each piezoelectric element 560 has a first electrode, a piezoelectric body, and a second electrode, and these portions are laminated in the Z1 direction in this order. One of the first electrode and the second electrode is an individual electrode disposed to be separated from another electrode of the same type for each piezoelectric element 560, and the drive signal Com is supplied from the control module 20 to the one electrode. The other electrode of the first electrode and the second electrode is a band-shaped common electrode extending in the direction along the Y-axis to be continuous over the plurality of piezoelectric elements 560, and for example, a constant potential is supplied to the other electrode. Examples of the metal material of the electrodes include metal materials such as platinum (Pt), aluminum (Al), nickel (Ni), gold (Au), and copper (Cu). Among these, one type can be used alone or two or more types can be used in the form of an alloy or a laminate. The piezoelectric body is formed of a piezoelectric material such as lead zirconate titanate (Pb(Zr,Ti)O₃). The piezoelectric body is integrally provided over the plurality of piezoelectric elements 560, or may be individually provided for each piezoelectric element 560.

The protective substrate 570 is a plate-shaped member provided on the surface of the vibration plate 550 facing the Z1 direction, protects the plurality of piezoelectric elements 560, and reinforces the mechanical strength of the vibration plate 550. Here, the plurality of piezoelectric elements 560 are housed in a space S between the protective substrate 570 and the vibration plate 550. The protective substrate 570 is formed of, for example, a resin material.

The case 580 is a case for storing the ink to be supplied to the plurality of pressure chambers C1. For example, the case 580 is formed of a resin material. The case 580 is provided with a flow path R2 for each of the first nozzle row Ln1 and the second nozzle row Ln2. The flow path R2 is a space coupled to the above-described flow path R1, and includes an elongated hole extending in the direction along the Y-axis in a plan view viewed in the direction along the Z-axis. The flow path R2 communicates with the nozzle N and functions as a reservoir R that stores the ink supplied to the plurality of pressure chambers C1 together with the flow path R1. The case 580 is provided with an inlet HL for supplying the ink to each reservoir R. The ink in each reservoir R is supplied to the pressure chamber C1 via each supply flow path Ra. The positions, the number, and other aspects of the inlets HL for each reservoir R are not limited to the examples illustrated in FIGS. 2 and 3, and can be freely determined.

The vibration absorbing body 540 is also called a compliance substrate, is a flexible resin film forming a wall surface of the reservoir R, and absorbs a pressure fluctuation in the ink in the reservoir R. The vibration absorbing body 540 may be a flexible thin plate formed of metal. A surface of the vibration absorbing body 540 facing the Z1 direction is bonded to the communication substrate 510 through an adhesive or the like.

The wiring substrate 590 is mounted on the surface of the vibration plate 550 facing the Z1 direction, and is a mounting component for electrically coupling the control module 20 and the liquid ejecting head 50. For example, the wiring substrate 590 is a flexible wiring substrate such as a chip on film (COF), a flexible printed circuit (FPC), or a flexible flat cable (FFC). The drive circuit 600 is mounted on the wiring substrate 590 according to the present embodiment. The drive circuit 600 switches whether or not to supply a pulse in the drive signal Com output from the control module 20 to each of the plurality of piezoelectric elements 560 of the liquid ejecting head 50 under the control of the control module 20. As described above, the wiring substrate 590 supplies the drive signal Com for driving the piezoelectric element 560. The wiring substrate 590 may be a rigid substrate. In this case, the drive circuit 600 is mounted on the rigid substrate or a flexible substrate coupled to the rigid substrate.

### 1-3: Nozzle

FIG. 4 is a cross-sectional view illustrating the nozzle N according to the first embodiment. As illustrated in FIG. 4, the nozzle N includes the first nozzle portion N1 and a second nozzle portion N2. The second nozzle portion N2 and the first nozzle portion N1 are arranged in this order in the ejection direction DN. In the example illustrated in the drawing, the first nozzle portion N1 and the second nozzle portion N2 are adjacent to each other.

The first nozzle portion N1 is a hole formed in the nozzle surface FN of the nozzle plate 530, and ejects the ink. A scalloped structure CS1 having unevenness is provided on the side surface NS1 of the first nozzle portion N1. That is, the first nozzle portion N1 has the scalloped structure CS1 having unevenness on the side surface NS1. The side surface NS1 is a surface along the ejection direction DN that is a direction in which the liquid is ejected from the first nozzle portion N1. The scalloped structure CS1 is formed, for example, by deep reactive ion etching such as the Bosch process.

The scalloped structure CS1 includes a plurality of convex portions 51 and a plurality of concave portions 52.

Each of the plurality of convex portions 51 is an annular protrusion that extends over the entire periphery along the peripheral direction of the first nozzle portion N1. Each of the plurality of concave portions 52 is an annular groove that extends over the entire periphery along the peripheral direction of the first nozzle portion N1. The plurality of convex portions 51 and the plurality of concave portions 52 are arranged in an axial direction of the first nozzle portion N1 such that the convex portion 51 and the concave portion 52 are alternately arranged. Here, the convex portion 51 is provided between two concave portions 52 adjacent to each other. In other words, the concave portion 52 is provided between two convex portions 51 adjacent to each other.

A wettable film 61 having wettability is provided on at least one of the plurality of convex portions 51. In the present embodiment, the wettable film 61 is provided on each of the convex portions 51 excluding a first convex portion 51-1 described below that is the convex portion 51 at a position closest to an opening OP of the first nozzle portion N1 among the plurality of convex portions 51.

The wettability refers to wetting property to the liquid. For example, the wettability may be evaluated such that a contact angle with pure water is less than 70°. A material for forming the wettable film 61 is not particularly limited as long as the wettability can be realized, and examples thereof include a monomolecular film having a hydroxy group or a carboxy group at a terminal and polysiloxane (PPSi). It is preferable that the wettable film 61 is formed of a material having wettability for the ink. For example, a contact angle between the ink having a surface tension of about 25 mN/m and the wettable film 61 is preferably less than 40°. Between the wettable film 61 and a surface of the nozzle plate 530, a protective layer formed of tantalum oxide or the like may be provided, or an adhesion layer such as a plasma-polymerized film of silicon may be provided.

In the example illustrated in the drawing, the wettable film 61 is provided over the entire area of the side surface NS1. However, in a region of the side surface NS1 excluding the vicinity of the tip of the convex portion 51, the wettable film 61 is covered with a liquid-repellent film 71 having liquid repellency. Accordingly, the wettable film 61 is exposed in the first nozzle portion N1 only in the vicinity of the tip of the convex portion 51. As a result, the wettability of the convex portion 51 is higher than the wettability of the concave portion 52 adjacent to the convex portion 51 in the ejection direction DN. In other words, the liquid repellency of the convex portion 51 is lower than the liquid repellency of the concave portion 52 adjacent to the convex portion 51 in the ejection direction DN. As a result, the meniscus ME is likely to be formed by the convex portion 51. In other words, the meniscus ME is not likely to be formed at the concave portion 52.

The liquid repellency represents that a contact angle with pure water is 100° or more. A material for forming the liquid-repellent film 71 is not particularly limited as long as the liquid repellency can be realized, and examples thereof include a fluorine-based resin material such as perfluoropolyether (PFPE) and a monomolecular film having a fluoro group at a terminal. It is preferable that the liquid-repellent film 71 is formed of a material having liquid repellency for the ink. For example, a contact angle between the ink having a surface tension of about 25 mN/m and the liquid-repellent film 71 is preferably 60° or more.

In the present embodiment, the liquid-repellent film 71 having liquid repellency is provided on each of the concave portions 52. As a result, the meniscus ME is not likely to be formed at the concave portion 52, and thus the meniscus ME is more likely to be formed at the convex portions 51. As a result, the position of the meniscus ME can be further stabilized.

In the example illustrated in the drawing, a liquid-repellent film 72 is provided on the nozzle surface FN of the nozzle plate 530. As a result, attachment of the ink to the surface can be suppressed. As in the liquid-repellent film 71, the liquid-repellent film 72 is formed of, for example, a fluorine-based resin material. The liquid-repellent film 72 may be a film that is formed together with the liquid-repellent film 71, or may be a film that is formed separately from the liquid-repellent film 71.

In addition, it is preferable that the liquid-repellent film 72 is continuous to the liquid-repellent film 71. By providing the liquid-repellent films 71 and 72 on an edge portion of the opening OP of the first nozzle portion N1 without a gap, attachment of the liquid droplets or mist to the edge portion can be suppressed, and ejection deflection of the liquid to be ejected can be suitably suppressed.

Examples of the configuration for increasing the wettability of the convex portion 51 to be higher than the wettability of the concave portion 52 include a configuration where the wettable film 61 is provided on the convex portion 51 and the liquid-repellent film 71 is provided on the concave portion 52, and a configuration where the wettable film 61 is provided on the convex portion 51 and both the wettable film 61 and the liquid-repellent film 71 are not provided on the concave portion 52.

The configuration where the wettable film 61 is provided on the convex portion 51 and the liquid-repellent film 71 is provided on the concave portion 52 can be obtained, for example, by forming the wettable film 61 and the liquid-repellent film 71 in this order on the side surface having the scalloped structure CS1 and subsequently removing the liquid-repellent film 71 to expose the wettable film 61 on the convex portion 51 through a plasma treatment having high straightness. The manufacturing method is not limited to this example, and can be freely determined. In addition, a method of forming the wettable film 61 and the liquid-repellent film 71 is not particularly limited, and a known film forming method can be used.

The wettable film 61 only needs to be provided on at least one convex portion 51 to be exposed in the nozzle N, and only needs to be provided on the convex portion 51 where the meniscus ME is to be formed. In addition, the wettable film 61 may be provided only on the convex portion 51, or may be provided not only on the convex portion 51 but also on the concave portion 52 in a state where the concave portion 52 is covered with a film having lower wettability than the wettable film 61 or the liquid-repellent film 71.

The liquid-repellent film 71 only needs to be provided on at least one concave portion 52 to be exposed in the nozzle N. For example, the liquid-repellent film 71 only needs to be formed at the concave portion 52 adjacent in the ejection direction DN to the convex portion 51 where the meniscus ME is to be formed, and the liquid-repellent film 71 does not need to be formed at the concave portion 52 distant from the convex portion 51 where the meniscus ME is to be formed.

It is preferable that the first nozzle portion N1 has a circular shape in a plan view along the ejection direction DN. As a result, the ejection of the liquid from the first nozzle portion N1 can be stabilized, as compared to an aspect where the shape of the first nozzle portion N1 in a plan view is a rectangular shape or the like. In addition, the convex portion 51 is provided along the circumference of the first nozzle portion N1. Therefore, the position of the meniscus ME in a radial direction of the nozzle N can be stabilized.

The second nozzle portion N2 is a hole positioned between the pressure chamber C1 and the first nozzle portion N1. A diameter W2 of the second nozzle portion N2 is more than a diameter W1 of the first nozzle portion N1. This way, by providing the second nozzle portion N2, supply and replacement of the liquid to and with the first nozzle portion N1 is facilitated. Therefore, accumulation of foreign matter generated in the first nozzle portion N1 on the concave portion 52 can be further suppressed. As a result, the position of the meniscus ME in the first nozzle portion N1 is stable.

A scalloped structure CS2 having unevenness is provided on a side surface NS2 of the second nozzle portion N2. That is, the second nozzle portion N2 has the scalloped structure CS2 having unevenness on the side surface NS2. The side surface NS2 is a surface along the ejection direction DN. The scalloped structure CS2 is formed, for example, by deep reactive ion etching such as the Bosch process.

The scalloped structure CS2 includes a plurality of convex portions 53 and a plurality of concave portions 54. Each of the plurality of convex portions 53 is an annular protrusion that extends over the entire periphery along the peripheral direction of the second nozzle portion N2. Each of the plurality of concave portions 54 is an annular groove that extends over the entire periphery along the peripheral direction of the second nozzle portion N2. The plurality of convex portions 53 and the plurality of concave portions 54 are arranged in an axial direction of the second nozzle portion N2 such that the convex portion 53 and the concave portion 54 are alternately arranged. Here, the convex portion 53 is provided between two concave portions 54 adjacent to each other. In other words, the concave portion 54 is provided between two convex portions 53 adjacent to each other.

A wettable film 62 having wettability is provided on each of the convex portions 53. As a result, accumulation of foreign matter or bubbles on the second nozzle portion N2 can be suppressed. The wettable film 62 only needs to be provided on at least one of the plurality of convex portions 53.

In the present embodiment, the wettable film 62 is provided over the entire area of the side surface NS2. Therefore, the wettable film 62 is also provided on each of the concave portions 54. As a result, accumulation of foreign matter or bubbles on the second nozzle portion N2 can be further suppressed. The wettable film 62 only needs to be provided on at least one of the plurality of concave portions 54.

A material for forming the wettable film 62 is not particularly limited as long as the wettability can be realized, and examples thereof include a monomolecular film having a hydroxy group or a carboxy group at a terminal and polysiloxane (PPSi) as in the wettable film 61. The wettable film 62 may be a film that is formed together with the wettable film 61, or may be a film that is formed separately from the wettable film 61. Between the wettable film 62 and a surface of the nozzle plate 530, a protective layer formed of tantalum oxide or the like may be provided, or an adhesion layer such as a plasma-polymerized film of silicon may be provided.

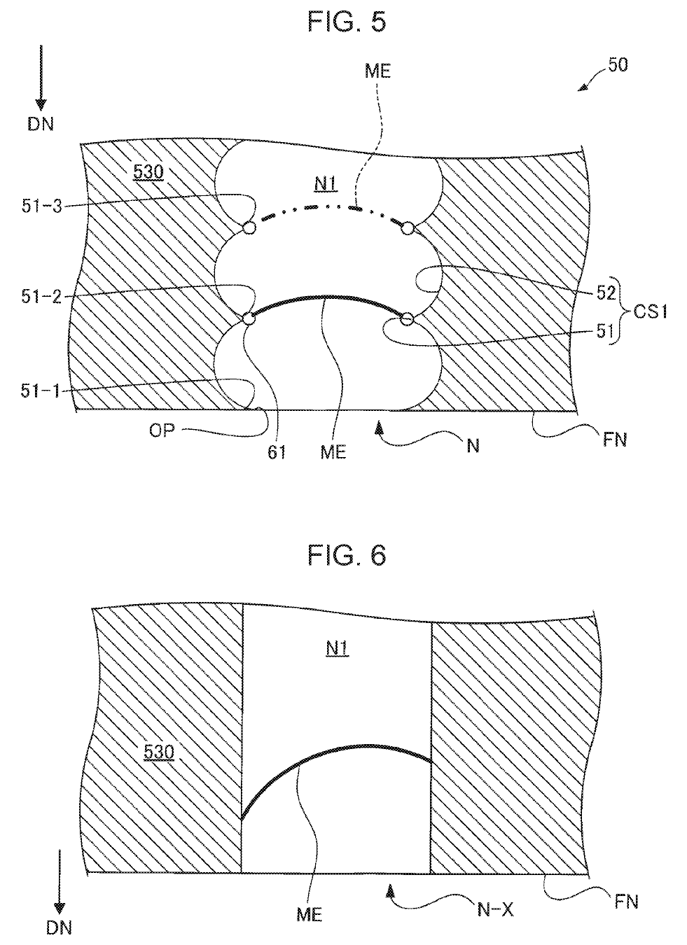

FIG. 5 is a schematic view illustrating the first nozzle portion N1 according to the first embodiment. In FIG. 5, for convenience of description, only the exposed portion of the wettable film 61 in the first nozzle portion N1 is schematically illustrated, and the liquid-repellent films 71 and 72 are not illustrated.

As illustrated in FIG. 5, the plurality of convex portions 51 include the first convex portion 51-1, a second convex portion 51-2, and a third convex portion 51-3.

The first convex portion 51-1 is the convex portion 51 at a position closest to the opening OP of the first nozzle portion N1 among the plurality of convex portions 51. The second convex portion 51-2 is one of the plurality of convex portions 51. In the example illustrated in the drawing, the second convex portion 51-2 is the convex portion 51 adjacent to the first convex portion 51-1. The third convex portion 51-3 is the convex portion 51 that is provided at a position more distant from the opening OP of the first nozzle portion N1 than the second convex portion 51-2 among the plurality of convex portions 51. In the example illustrated in the drawing, the third convex portion 51-3 is the convex portion 51 adjacent to the second convex portion 51-2. The second convex portion 51-2 may be the convex portion 51 other than the convex portion 51 adjacent to the first convex portion 51-1. The third convex portion 51-3 only needs to be the convex portion 51 that is provided at a position more distant from the opening of the first nozzle portion N1 than the second convex portion 51-2 among the plurality of convex portions 51, and may be the convex portion 51 other than the convex portion 51 adjacent to the second convex portion 51-2.

In the liquid ejecting head 50, the first nozzle portion N1 includes the scalloped structure CS1. As a result, the position of the meniscus ME can be structurally stabilized as compared to an aspect not including the scalloped structure CS1. Further, by providing the wettable film 61 on the convex portion 51 of the scalloped structure CS1, the meniscus ME is more likely to be formed at the convex portion 51 than on the concave portion 52. Therefore, the position of the meniscus ME can be further stabilized.

This way, the position of the meniscus ME is stabilized. Therefore, a variation in the amount of the ink to be ejected caused by a variation in the meniscus ME can be suppressed, and thus, a variation in the natural resonance frequency of the liquid in the vicinity of the nozzle N can be suppressed.

In addition, the wettability of the concave portion 52 of the first nozzle portion N1 is lower than the wettability of the convex portion 51. Therefore, accumulation of foreign matter on the concave portion 52 can be suppressed. As a result, the position of the meniscus ME can be suppressed from being unstable due to foreign matter. In addition, large foreign matter is not likely to be formed in the first nozzle portion N1. Therefore, flying deflection of the liquid caused by foreign matter can be prevented.

In FIG. 5, the meniscus ME that is formed at the second convex portion 51-2 is indicated by a solid line, and the meniscus ME that is formed at the third convex portion 51-3 is indicated by a two-dot chain line.

In the present embodiment, the first convex portion 51-1 divides the opening OP, and the wettable film 61 is not provided on the first convex portion 51-1. Thus, the formation of the meniscus ME at the first convex portion 51-1 can be suppressed. As a result, leakage or attachment of the liquid to the vicinity of the opening of the first nozzle portion N1 can be suppressed.

The control portion 21 changes the position of the meniscus ME depending on each of the positions of the plurality of convex portions 51. As a result, when the natural resonance frequency of the liquid in the vicinity of the nozzle N is adjusted, the amount of the liquid that fills the nozzle N changes by controlling the back pressure. Therefore, by reducing the mass of the liquid in the nozzle N, the natural resonance frequency can be adjusted to be increased. In addition, when the ejection amount or the ejection rate of the liquid from the nozzle N is adjusted, the natural resonance period can be adjusted to be shorter. Therefore, using a change in the optimum length of the retention time of a terminal potential of an expansion element in the drive signal, the mass or ejection rate of the liquid in the nozzle N can be controlled. Further, when ejection characteristics generated by the manufacturing variation in the length of the nozzle N are adjusted, the amount of the ink that fills the nozzle N changes by controlling the back pressure. Therefore, the effective length of the nozzle can be controlled.

The control portion 21 can execute a first mode and a second mode. The first mode is a mode where the back pressure of the liquid in the nozzle N is a first back pressure. The second mode is a mode where the back pressure of the liquid in the nozzle N is a second back pressure that is a back pressure higher than the first back pressure. This way, the liquid ejecting head 50 includes the first mode and the second mode.

In the first mode, the meniscus ME is formed at the second convex portion 51-2. On the other hand, in the second mode, the meniscus ME is formed at the third convex portion 51-3. As a result, when it is desired to reduce the ejection amount of the liquid from the nozzle N, the position of the meniscus ME can be positioned closer to the second nozzle portion N2 side in the second mode. On the other hand, when it is desired to increase the ejection amount of the liquid from the nozzle N, the position of the meniscus ME can be positioned closer to the opening OP side in the first mode. Here, when the back pressure is high, the liquid is likely to be supplied to the nozzle N, and thus the stability is high. For example, when it is desired to increase the ejection frequency of the liquid from the nozzle N in a high-frequency mode, the meniscus ME can be positioned closer to the second nozzle portion N2 side in the second mode. On the other hand, when it is desired to reduce the ejection frequency of the liquid from the nozzle N in a normal printing mode, the position of the meniscus ME can be positioned closer to the opening OP side in the first mode. In addition, in another example, in a period where the carriage 41 is moving in a printing mode of a serial printer, the position of the meniscus ME can be positioned closer to the second nozzle portion N2 side in the second mode, and thus liquid leakage can be reduced. On the other hand, in a period where the carriage 41 is stopped in a maintenance mode of a serial printer, the position of the meniscus ME can be positioned closer to the opening OP side in the first mode, and thus the maintenance can be efficiently performed.

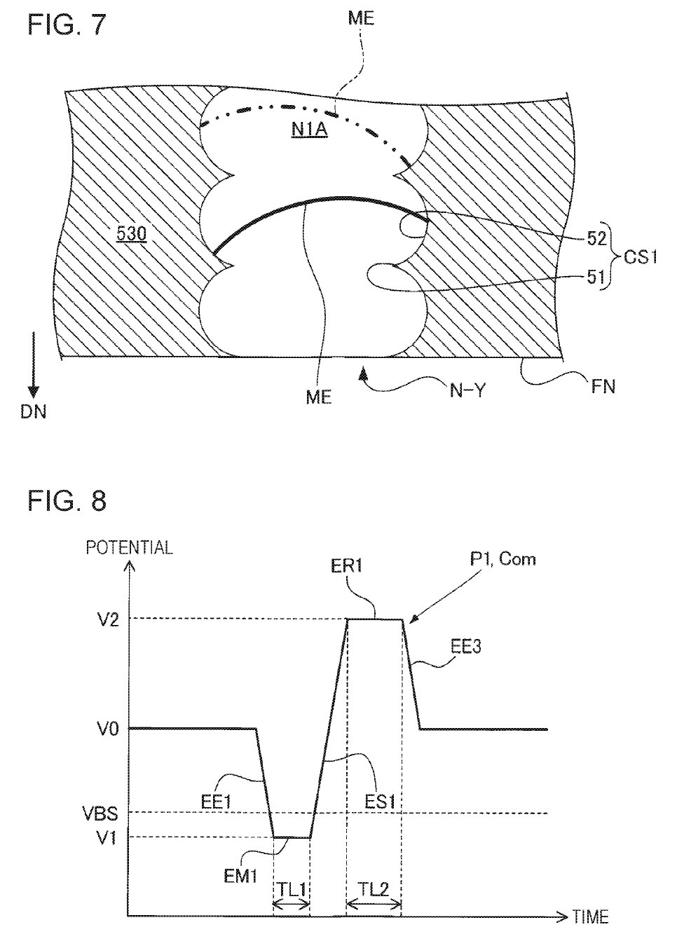

FIG. 6 is a diagram illustrating a nozzle N-X not having the scalloped structure CS1 and having uniform wettability on a wall surface. FIG. 7 is a diagram illustrating a nozzle N-Y having the scalloped structure CS1 and having uniform wettability on a wall surface.

In the nozzle N-X, the position and the posture of the meniscus ME are not stable. The wall surface of the nozzle N-X does not have the scalloped structure CS1, and has uniform wettability. Therefore, there is a small difference in surface energy on the wall surface. Therefore, there is no position where the meniscus ME is stably formed in terms of energy, and the position and the posture of the meniscus ME are not stable. In addition, the position and the posture of the meniscus ME are not stable, and thus a variation in the natural resonance frequency of the liquid in the vicinity of the nozzle N-X increases.

In the nozzle N-Y, the scalloped structure CS1 is provided as compared to the nozzle N-X. Therefore, although the position and the posture of the meniscus ME are stable, the wettability is uniform on the wall surface, and thus the position and the posture of the meniscus ME in the concave portion 52 are likely to change.

On the other hand, in the above-described nozzle N, by providing the wettable film 61 on the convex portion 51 of the scalloped structure CS1, the meniscus ME is likely to be more stably formed at the convex portion 51 structurally and in terms of energy as compared to the concave portion 52. Therefore, the position of the meniscus ME can be further stabilized.

FIG. 8 is a diagram illustrating an example of the drive signal Com. The drive signal Com includes an ejection pulse P1 as illustrated in FIG. 8.

The ejection pulse P1 is a pulse for ejecting the ink from the nozzle N as liquid droplets. By supplying the ejection pulse P1 to the piezoelectric element 560, a pressure fluctuation in the ink in the pressure chamber C1 is generated such that the ink is ejected from the nozzle N. In the example illustrated in FIG. 8, the ejection pulse P1 includes an expansion element EE1, an expansion maintaining element EM1, a contraction element ES1, a contraction maintaining element ER1, and a damping element EE3 in this order.

The expansion element EE1 is a potential element that changes from an intermediate potential V0 to a potential V1 to reduce the pressure in the pressure chamber C1. That is, the expansion element EE1 is an element that expands the pressure chamber C1 to draw the liquid from the first nozzle portion N1 and the supply flow path Ra to the pressure chamber C1 side. The expansion maintaining element EM1 is a potential element that is coupled to the expansion element EE1 to maintain the potential V1 in a period TL1. The contraction element ES1 is a potential element that is coupled to the expansion maintaining element EM1 and changes from the potential V1 to a predetermined terminal potential to increase a pressure in the pressure chamber C1. The contraction maintaining element ER1 is a potential element that is positioned after the contraction element ES1 and maintains a potential V2 that is higher than or equal to the terminal potential of the contraction element ES1 over a period TL2. That is, the contraction element ES1 is an element that contracts the pressure chamber C1 to eject the liquid from the first nozzle portion N1. The damping element EE3 is a potential element that changes from the terminal potential of the contraction maintaining element ER1 to the intermediate potential V0 to reduce a pressure in the pressure chamber C1, and controls pressure vibration generated in the pressure chamber C1 when the contraction maintaining element ER1 is supplied to the piezoelectric element 560.

This way, when the liquid is ejected by applying the ejection pulse P1 having a waveform that draws the liquid droplets into the nozzle N and ejects the liquid, the position and the posture of the meniscus ME formed when the liquid droplets are drawn into the nozzle N are likely to be unstable. Particularly when the piezoelectric element 560 is driven at a high speed, the position and the posture of the meniscus ME during the drawing are likely to change depending on ejection. According to the present embodiment, the position of the meniscus ME is stabilized. Therefore, ejection deflection of the liquid from the nozzle N can be suppressed.

The ejection pulse P1 according to the present embodiment includes an expansion element EE1, an expansion maintaining element EM1, a contraction element ES1, a contraction maintaining element ER1, and a damping element EE3 in this order, but the present disclosure is not limited thereto. For example, the ejection pulse P1 only needs to include at least the expansion element EE1 and the contraction element ES1.

### 2. Second Embodiment

Hereinafter, a second embodiment of the present disclosure will be described. In the embodiment described below, elements having the same effects and functions as those of the first embodiment will be denoted by the reference numerals used in the description of the first embodiment, and each of the elements will not be described in detail, as appropriate.

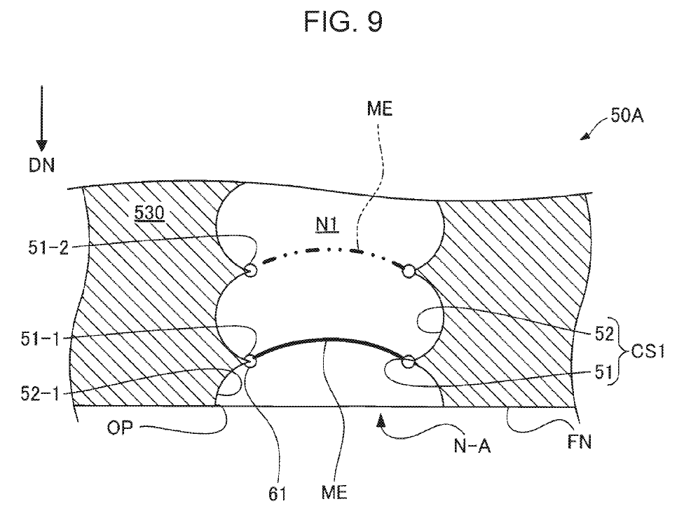

FIG. 9 is a cross-sectional view illustrating a nozzle N-A according to the second embodiment. The nozzle N-A is configured to be the same as the nozzle N according to the first embodiment, except that the first convex portion 51-1 is positioned closer to the inside of the first nozzle portion N1 than the opening OP, and the wettable film 61 is also provided on the first convex portion 51-1. In the present embodiment, it can be said that the first convex portion 51-1 is an example of “second convex portion”, and it can be said that the second convex portion 51-2 is an example of “third convex portion”.

In addition, the nozzle N-A according to the present embodiment includes a first concave portion 52-1 having a larger diameter than the first convex portion 51-1 between the first convex portion 51-1 and the opening OP in the ejection direction DN without including the convex portion. Accordingly, it can be said that the nozzle N-A does not include the convex portion corresponding to “first convex portion 51-1” according to the first embodiment.

This way, in the present embodiment, the wettable film 61 is also provided on the first convex portion 51-1 that is the convex portion 51 at a position closest to the opening of the first nozzle portion N1 among the plurality of convex portions 51. Here, the first concave portion 52-1 is provided between the opening OP of the first nozzle portion N1 and the first convex portion 51-1. The first concave portion 52-1 is the concave portion 52 closest to the opening OP among the plurality of concave portions 52, and is the concave portion 52 having a larger diameter than the first convex portion 51-1. As a result, the first convex portion 51-1 is positioned inside the opening OP of the first nozzle portion N1. Therefore, even when the meniscus ME is formed at the first convex portion 51-1, leakage or attachment of the liquid to the vicinity of the opening of the first nozzle portion N1 can be suppressed.

In the present embodiment, the first concave portion 52-1 faces the opening OP. Therefore, the liquid-repellent film 71 that is provided on the first concave portion 52-1 and the liquid-repellent film 72 that is provided on the nozzle surface FN are likely to be formed to be continuous to each other. Accordingly, by providing the liquid-repellent films 71 and 72 on an edge portion of the opening OP of the first nozzle portion N1 without a gap, attachment of the liquid droplets or mist to the edge portion can be suppressed, and ejection deflection of the liquid to be ejected can be suitably suppressed.

With the above-described second embodiment, the position of the meniscus ME formed in the nozzle N-A can be stabilized.

### 3. Third Embodiment

Hereinafter, a third embodiment of the present disclosure will be described. In the embodiment described below, elements having the same effects and functions as those of the first embodiment will be denoted by the reference numerals used in the description of the first embodiment, and each of the elements will not be described in detail, as appropriate.

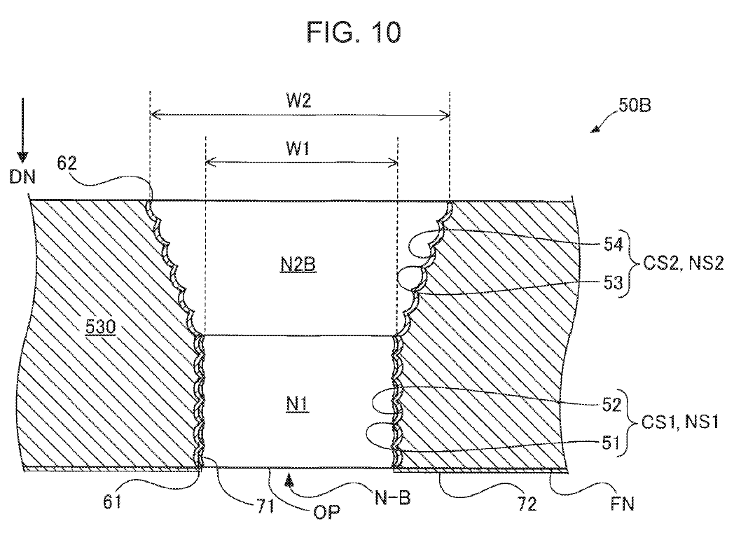

FIG. 10 is a cross-sectional view illustrating a nozzle N-B according to a third embodiment. The nozzle N-B has the same configuration as the nozzle N according to the first embodiment, except that it includes a second nozzle portion N2B instead of the second nozzle portion N2 according to the first embodiment.

The second nozzle portion N2B has a tapered shape where the diameter decreases toward the first nozzle portion N1. As a result, even when a large pulling waveform is applied to eject a large amount of ink, entrance of bubbles into the nozzle N can be suppressed.

The second nozzle portion N2B has the scalloped structure CS2 having unevenness that includes the convex portions 53 and the concave portions 54. The wettable film 62 having wettability is provided on each of the convex portions 53 in the scalloped structure CS2 of the second nozzle portion N2B. As a result, accumulation of foreign matter or bubbles on the second nozzle portion N2B can be further suppressed.

With the above-described third embodiment, the position of the meniscus ME formed in the nozzle N-B can be stabilized.

### 4. Modification Examples

Each of the embodiments described above can be variously modified. Specific modification aspects that can be applied to each of the above-described forms will be described below. The aspects freely selected from the following examples can be appropriately combined with each other within a range of not being inconsistent with each other.

### 4-1: Modification Example 1

In the above-described embodiments, the aspect where the nozzle N includes the two portions having different diameters is described, but the present disclosure is not limited to this aspect. The nozzle N may be formed of only the first nozzle portion N1 having a uniform width or a tapered width, or the nozzle N may have three or more portions having different diameters. That is, in the above-described embodiments, the aspect where the nozzle N includes the second nozzle portions N2 and N2B is described, but the present disclosure is not limited to this aspect. The second nozzle portions N2 and N2B may be removed, or a third portion or the like having a different diameter from the first nozzle portions N1 and N1A and the second nozzle portions N2 and N2B may be added.

### 4-2: Modification Example 2

In the above-described embodiments, the aspect where the scalloped structure CS2 is provided on the side surface NS2 of the second nozzle portions N2 and N2B is described, but the present disclosure is not limited to this aspect. The scalloped structure CS2 may be removed.

### 4-3: Modification Example 3

In each of the above-described embodiments, a serial-type liquid ejecting apparatus 100, which reciprocates the carriage 41 equipped with the liquid ejecting head 50, is described, but the present disclosure is also applicable to a line-type liquid ejecting apparatus in which the plurality of nozzles N are distributed over the entire width of the recording medium M.

### 4-4: Modification Example 4

The liquid ejecting apparatus 100 described in the above-described embodiments may be employed in various apparatuses such as a facsimile machine and a copier, in addition to an apparatus dedicated to printing, and the application of the present disclosure is not particularly limited. Note that the application of the liquid ejecting apparatus is not limited to printing. For example, a liquid ejecting apparatus that ejects a solution of a coloring material is used as a manufacturing device that forms a color filter of a display device such as a liquid crystal display panel. In addition, a liquid ejecting apparatus that ejects a solution of a conductive material is used as a manufacturing apparatus that forms a wiring or an electrode on a wiring substrate. In addition, a liquid ejecting apparatus that ejects a solution of an organic substance related to a living body is used, for example, as a manufacturing apparatus that manufactures a biochip.

What is claimed is:

1. A liquid ejecting head comprising:
a nozzle that ejects liquid, wherein
the nozzle includes a first nozzle portion that ejects the liquid,
the first nozzle portion includes a scalloped structure having a plurality of convex portions and a plurality of concave portions on a side surface along an ejection direction in which the liquid is ejected from the first nozzle portion,
a wettable film having wettability is provided on at least one of the plurality of convex portions in the scalloped structure of the first nozzle portion, and
wettability of the at least one convex portion is higher than wettability of a concave portion adjacent to the at least one convex portion in the ejection direction.

2. The liquid ejecting head according to claim 1, wherein a liquid-repellent film having liquid repellency is provided on at least one of the plurality of concave portions in the scalloped structure of the first nozzle portion.

3. The liquid ejecting head according to claim 1, wherein a wettable film is not provided on a first convex portion that is a convex portion at a position closest to an opening of the first nozzle portion among the plurality of convex portions.

4. The liquid ejecting head according to claim 1, wherein
the at least one convex portion includes a first convex portion that is a convex portion at a position closest to an opening of the first nozzle portion among the plurality of convex portions, and
a first concave portion is provided between the opening of the first nozzle portion and the first convex portion.

5. The liquid ejecting head according to claim 1, wherein
a position of a meniscus to be formed in the first nozzle portion is controlled by a control portion,
the first nozzle portion includes
the plurality of convex portions including the at least one convex portion on which a wettable film is provided, and
the plurality of concave portions on which a liquid-repellent film is provided, and
the control portion changes the position of the meniscus depending on each of positions of the plurality of convex portions.

6. The liquid ejecting head according to claim 5, wherein
a first mode where a back pressure of the liquid in the nozzle is a first back pressure and a second mode where the back pressure of the liquid in the nozzle is a second back pressure that is a back pressure higher than the first back pressure are provided,
the at least one convex portion includes a second convex portion that is one of the plurality of convex portions and a third convex portion that is a convex portion provided at a position more distant from an opening of the first nozzle portion than the second convex portion,
in the first mode, a meniscus is formed in the second convex portion, and
in the second mode, a meniscus is formed in the third convex portion.

7. The liquid ejecting head according to claim 1, wherein in a plan view along the ejection direction, the first nozzle portion has a circular shape.

8. The liquid ejecting head according to claim 1, further comprising:
a piezoelectric element that is driven by a drive signal; and
a pressure chamber that is filled with the liquid to be ejected from the nozzle and where a volume changes depending on the drive of the piezoelectric element, wherein
the nozzle includes a second nozzle portion that is positioned between the pressure chamber and the first nozzle portion and has a larger diameter than the first nozzle portion.

9. The liquid ejecting head according to claim 8, wherein
the second nozzle portion has a scalloped structure having a plurality of convex portions, and
at least one of the plurality of convex portions in the scalloped structure of the second nozzle portion includes a wettable film having wettability.

10. The liquid ejecting head according to claim 8, wherein a wettable film having wettability is provided on at least one concave portion in the scalloped structure of the second nozzle portion.

11. The liquid ejecting head according to claim 8, wherein the second nozzle portion has a tapered shape where a diameter decreases toward the first nozzle portion.

12. The liquid ejecting head according to claim 11, wherein
the second nozzle portion has a scalloped structure having a plurality of convex portions, and
a wettable film having wettability is provided on at least one of the plurality of convex portions in the scalloped structure of the second nozzle portion.

13. The liquid ejecting head according to claim 1, further comprising:
a piezoelectric element that is driven by a drive signal; and
a pressure chamber that is filled with the liquid to be ejected from the first nozzle portion and where a volume changes depending on the drive of the piezoelectric element, wherein
the drive signal includes
an element that expands the pressure chamber to draw the liquid from the first nozzle portion to the pressure chamber side, and
an element that contracts the pressure chamber to eject the liquid from the first nozzle portion.
